(19) United States
(12) Patent Application Publication
(10) Pub. No.: US 2003/0200969 A1
(43) Pub. Date: Oct. 30, 2003

(54) Gas mask with a ring-shaped sealing element and breathing filter with a ring-shaped sealing element

(76) Inventors: Hartmut Kintzel, Lubeck (DE); Ralf Drews, Lubeck (DE); Markus Kater, Herrnburg (DE)

Correspondence Address: McGLEW AND TUTTLE, P.C., SCARBOROUGH STATION, SCARBOROUGH, NY, 10510-0827, US

(21) Appl. No.: 10/361,300

(22) Filed: Feb. 10, 2003

(30) Foreign Application Priority Data
Apr. 24, 2002 (DE) 102 18 199.3-22

(51) Int. Cl. A62B 18/08

(52) U.S. Cl. 128/206.12

(57) ABSTRACT

A gas mask (1) is provided with a sealing element (5) of a special shape. The sealing element is easy to handle for use with a plug-in breathing filter (4). The sealing element also provides good sealing against gases from the environment. The sealing element (5) of the gas mask (4) seals the outlet (3) for the breathing filter (4) all around and has a cross section that is limited axially by two parallel, flat, peripheral surfaces (51, 52), whose radial inner limiting surface (53) is concave, and whose radial outer limiting surface (54) extends axially from the outside to the inside first concavely and passes over in the middle area into an elevation (55) tapering outwardly in the radial direction.

### FIELD OF THE INVENTION

The present invention pertains to a gas mask with a ring-shaped sealing element and to a breathing filter with a ring-shaped sealing element.

### BACKGROUND OF THE INVENTION

As so-called full masks, such gas masks have a mask body with protective lenses for the protection of the eyes and the face of the mask user. In addition, gas masks have at least one uniform plug-type connection for a breathing filter that can be plugged in. The filter has a filling specifically effective for the retention of at least one certain gas, so that the mask user is also reliably protected from gases that are hazardous to health and toxic gases by means of the gas mask with breathing filter.

For handling a gas mask, it is important, on the one hand, for a plugged-in breathing filter to be sealed satisfactorily on the outlet and to be fastened, and, on the other hand, that it can be plugged in and removed easily. The prior-art sealing elements used hitherto, so-called O-rings, require the application of a relatively strong force for handling the plugging in or the removal of the breathing filter on or from the plug-in connection of the gas mask. Diameter tolerances can be compensated only slightly because of the small compensating capacity of the circular cross section of an O-ring without adversely affecting the application of force during the handling of the filter and reliable sealing.

### SUMMARY OF THE INVENTION

The basic object of the present invention is correspondingly to provide a gas mask with a sealing element that is improved in terms of easier handling and more reliable sealing.

According to the invention, a gas mask is provided with a ring-shaped sealing element which peripherally seals the outlet for the breathing filter. The ring-shaped sealing element has a cross section limited axially by two parallel, flat, peripheral surfaces. The ring-shaped sealing element has a radial inner limiting surface that is concave and has a radial outer limiting surface that first extends axially concavely from the outside to the inside and passes over in the middle area into an elevation tapering outwardly in the radial direction.

An essential advantage of the present invention arises from the cooperation of the radial outer limiting surface with elevation of the sealing element and the concave inner limiting surface such that the application of a weaker force is necessary than before for deforming the sealing element. Furthermore, greater manufacturing tolerances can be compensated due to the design according to the present invention, as a consequence of which the force of deformation of the sealing element to be overcome during the plugging in of the breathing filter is approximately constant.

If the breathing filter is mounted in a skewed position, a sealing element with circular cross section can yield only slightly and become damaged as a result, as a result of which the tightness of the connection is no longer guaranteed. Yielding is possible and the risk for damage is reduced to a minimum in the novel sealing element in the case of skewed mounting of the filter because of the cross-sectional design.

The middle area with the elevation tapering outwardly in the radial direction may be rounded. The flanks of the outwardly tapering elevation may be provided so as to expand continuously and form an angle β of about 40°.

The radial inner limiting surface, extending convexly, may pass over into the parallel and flat, peripheral surfaces axially limiting the sealing element.

The sealing element may consist of a silicone elastomer with a ball hardness of about 50 according to DIN 53 519.

The breathing filter may be fixed by a snap-in element of the said gas mask.

According to another aspect of the invention a breathing filter is provided with a ring-shaped sealing element which peripherally seals the breathing filter. The ring-shaped sealing element has a cross section limited axially by two parallel, flat, peripheral surfaces. The ring-shaped sealing element has a radial inner limiting surface that is concave and has a radial outer limiting surface that first extends axially concavely from the outside to the inside and passes over in the middle area into an elevation tapering outwardly in the radial direction.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a vertical section through a gas mask in the area of the outlet for a breathing filter; and

FIG. 2 is a cross sectional view through a ring-shaped sealing element for the outlet for a breathing filter of a gas mask.

### DESCRIPTION OF THE PREFERRED EMBODIMENT

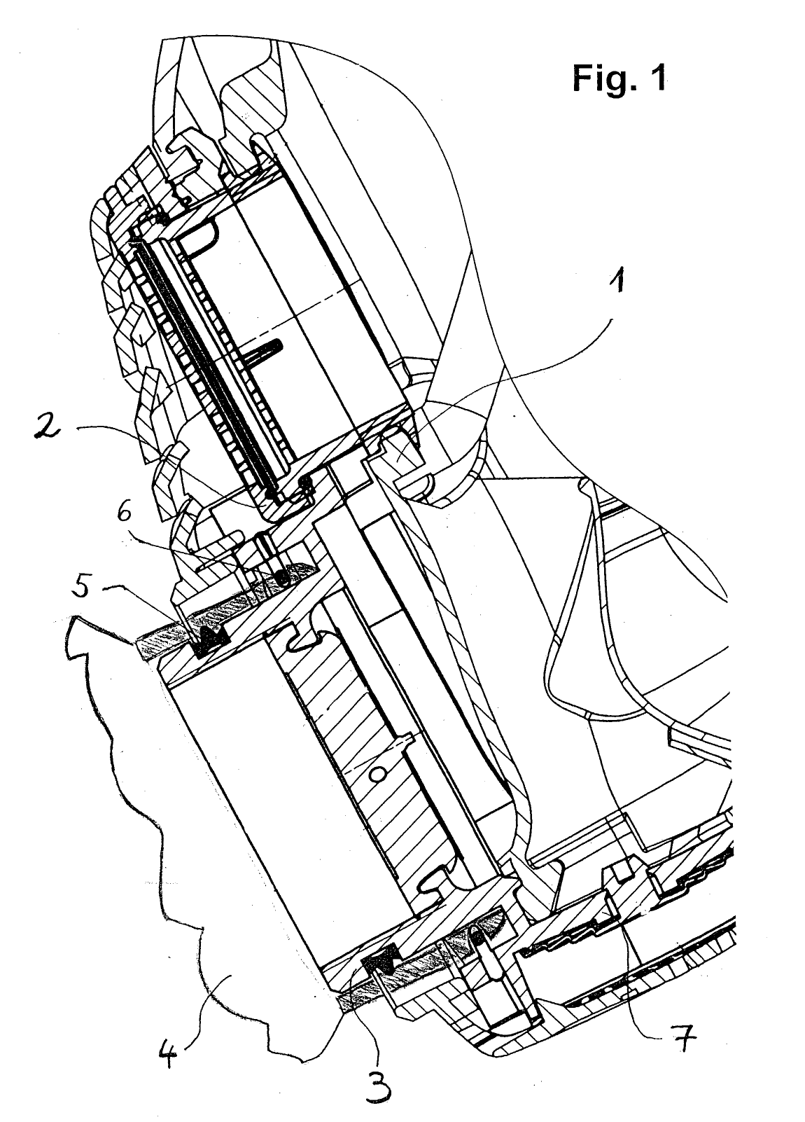

Referring to the drawings in particular, FIG. 1 shows a sectional view of a detail of a gas mask 1. As full masks, such gas masks have an elastic, gas-impermeable mask body with protective lenses for the protection of the eyes and the face of the mask user. A speaking membrane 2 is used to transmit speech to the environment. An expiration valve 7 is present as a directional valve only for releasing the expired air of the mask user to the environment. Breathing in takes place via a plug-in breathing filter 4, which is filled with a filling specific for the retention of one or more gases, so that the mask user is protected from gases that are hazardous to health or toxic gases during breathing in.

The outlet is standardized or has at least a uniform design for a given gas mask manufacturer, so that a breathing filter 4 with a suitable filling for the particular gas to be retained can be used depending on the application. The breathing filter 4 is plugged to the outlet 3 of the gas mask 1 over and beyond the sealing element 5, and a preferably spring-actuated snap-in element 6 of the gas mask 1 snaps into a notch of the breathing filter 4 and holds same.

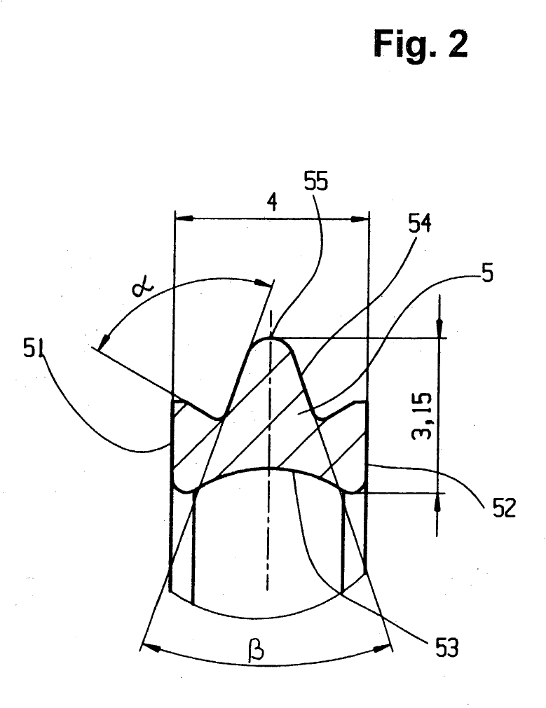

An enlarged view of the cross section of the novel sealing element 5 is shown in FIG. 2. It is inserted in a ring-shaped form into a peripheral groove of the outlet 3. The sealing element 5 consists of a silicone elastomer with a ball hardness of about 50 according to DIN 53 519. As a result of the cross-sectional shape, only a weak force of deformation must be applied when a breathing filter 4 is plugged onto the outlet 3 and is moved over the sealing element 5 yielding up to the limitation formed by the groove. Due to the design of the sealing element 5 according to the present invention, manufacturing tolerances can be better compensated, as a result of which the forces of deformation of the sealing element 5 that are to be overcome during the plugging of the breathing filter 4 to the outlet 3 are approximately constant.

The cross section of the sealing element 5 is limited laterally, i.e., axially, by two parallel, flat, peripheral surfaces 51, 52. The radial inner limiting surface 53 is concave, so that a predetermined area of sag is left in the groove of the outlet 3 receiving the sealing element 5 for the case in which the sealing element 5 is deformed inwardly in the radial direction during the attachment of the plug-in breathing filter 4. Good sealing is achieved as a result along with easier handling.

In the exemplary embodiment, the radial inner limiting surface 53 passes over, ending convexly, into the surfaces 51, 52.

The radial outer limiting surface 54 of the sealing element 5 extends, beginning from the surfaces 51, 52, first concavely and passes over into a rounded elevation tapering continuously outwardly in the radial direction. The angle α is approx. 80°, and the angle β is approx. 40°.

The sealing ring may be used in combination with the breathing filter for other applications including related and similar breathing system applications.

While specific embodiments of the invention have been shown and described in detail to illustrate the application of the principles of the invention, it will be understood that the invention may be embodied otherwise without departing from such principles.

What is claimed is:

1. A gas mask comprising:
a mask breathing filter outlet part with a ring seal space;
a breathing filter for connection with said mask outlet; and
a ring-shaped sealing element peripherally sealing the breathing filter outlet, said ring-shaped sealing element having a cross section limited axially by two parallel flat peripheral surfaces and having a concave radial inner limiting surface and having a radial outer limiting surface that first extends axially concavely from the outside to the inside and passes over in a middle area into an elevation tapering outwardly in the radial direction.

2. A gas mask in accordance with claim 1, wherein said elevation is rounded.

3. A gas mask in accordance with claim 2, wherein flanks of said elevation expand continuously and form an angle β of about 40°.

4. A gas mask in accordance with claim 1, wherein the radial inner limiting surface extending convexly passes over into said parallel and flat peripheral surfaces axially limiting the sealing element.

5. A gas mask in accordance with claim 1, wherein said sealing element consists of a silicone elastomer with a ball hardness of about 50 according to DIN 53 519.

6. A gas mask in accordance with claim 1, further comprising a snap-in element, wherein the breathing filter is fixed by said snap-in element.

7. A breathing filter and sealing ring, comprising:
a breathing filter with an annular seal engagement recess; and
a ring-shaped sealing element peripherally sealing the breathing filter, said ring-shaped sealing element having a cross section limited axially by two parallel flat peripheral surfaces and having a concave radial inner limiting surface and having a radial outer limiting surface that first extends axially concavely from the outside to the inside and passes over in a middle area into an elevation tapering outwardly in the radial direction, said elevation for engaging said annular seal engagement recess.

8. A breathing filter and sealing ring in accordance with claim 7, wherein said elevation is rounded.

9. A breathing filter and sealing ring in accordance with claim 8, wherein flanks of said elevation expand continuously and form an angle β of about 40°.

10. A breathing filter and sealing ring in accordance with claim 7, wherein the radial inner limiting surface extending convexly passes over into said parallel and flat peripheral surfaces axially limiting the sealing element.

11. A breathing filter and sealing ring in accordance with claim 7, wherein said sealing element consists of a silicone elastomer with a ball hardness of about 50 according to DIN 53 519.

12. A filter seal comprising:
a ring-shaped sealing element for peripherally sealing the filter, said ring-shaped sealing element having a cross section limited axially by two parallel flat peripheral surfaces and having a concave radial inner limiting surface and having a radial outer limiting surface that first extends axially concavely from the outside to the inside and passes over in a middle area into an elevation tapering outwardly in the radial direction.

13. A gas mask in accordance with claim 12, wherein said elevation is rounded.

14. A gas mask in accordance with claim 13, wherein flanks of said elevation expand continuously and form an angle β of about 40°.

15. A gas mask in accordance with claim 13, wherein the radial inner limiting surface extending convexly passes over into said parallel and flat peripheral surfaces axially limiting the sealing element.

16. A gas mask in accordance with claim 13, wherein said sealing element consists of a silicone elastomer with a ball hardness of about 50 according to DIN 53 519.
